(19) United States
(12) Patent Application Publication
(10) Pub. No.: US 2017/0079296 A1
(43) Pub. Date: Mar. 23, 2017

(54) Methods For Treating Plants Or Fruits

(71) Applicants: The United States of America, as represented by the Secretary of Agriculture, Washington, DC (US); University of Maryland, College Park, MD (US)

(72) Inventors: Yaguang Luo, Bethesda, MD (US); Boce Zhang, Olney, MD (US)

(21) Appl. No.: 14/861,086

(22) Filed: Sep. 22, 2015

(51) Int. Cl. A23B 7/152

(52) U.S. Cl. CPC A23B 7/152

(57) ABSTRACT

Methods for treating plants or fruits, involving contacting the plants or fruits with a solvothermal prepared metal-organic framework which releases at least one gas (e.g., ethylene) to treat the plants or fruits.

### BACKGROUND OF THE INVENTION

Methods are described for treating plants or fruits, involving contacting the plants or fruits with a solvothermal prepared metal-organic framework which releases at least one gas (e.g., ethylene) to treat the plants or fruits.

Gaseous plant hormone, ethylene, acts at trace levels to regulate the ripening of climacteric fruits, the opening of flowers, the abscission of leaves, and dormancy of seeds (Clendennen, S., and G. May, Plant Physiol., 115: 463-469 (1997)). Ethylene is considered by FDA as generally recognized as safe (GRAS), and found not harmful or toxic to humans, and has broad applications in both preharvest and postharvest stages. Ethylene gas has been widely used commercially to stimulate ripening of bananas, avocados, tomatoes, mangos, etc. (Burg, S., and E. A. Bur, Plant Physiol., 37(2): 179-189 (1962)). However, ethylene is highly flammable and combustible at concentrations above 27,000 ppm, and therefore requires special care during shipping, storage, and application (Hilado, C., and H. Cumming, Fire Technol., 13(3) 195-198 (1977)). The most common sources of ethylene gas are catalytically generated during the incomplete combustion of organic fuels of propane and natural gas, which also requires on-site maintenance of flammable gases (Frontline Services; California Division of Occupational Safety and Health). Therefore, direct application or on-site generation of ethylene gas is difficult and unsafe to handle at distributor or retail warehouses and consumer homes.

Ethephon (2-chloroetilfosfonic acid) is a commercial product developed to form ethylene gas. Ethephon is approved for preharvest application on processing tomatoes and table grapes with a maximum residue limit of 2 ppm via direct spray or dipping of the ethephon solutions on produce surfaces (Ban, T., et al., Scientia Horticulturae, 112 (3): 278-281 (2007)). Natural degradation generates ethylene when ethephon reaches the internal plant tissues (Yahia, A., et al., Plant Science, 133(1): 9-15 (1998); Foster, K., et al., Crop Science, 32(6): 1345-1352 (1992)). Ethephon is not approved for postharvest application via direct spray or dipping, but it is possible to use the ethylene gas liberated from the ethephon (Kader, A., Postharvest Technology of Horticultural Crops, 3rd Edition, Chapter 16, page 157, University of California, Agriculture and Natural Resources, Publication 3529, 2011). To use ethephon in postharvest warehouses or retail facilities, caustic soda (NaOH) pellets must be added to the solution to neutralize the ethephon and liberate ethylene, but the caustic soda and ethephon are both corrosive and unsafe to handle (Kader 2011). In addition, ethephon is a pesticide which may leave toxic residues on the produce surface. The acute oral lethal dose (LD₅₀) of ethephon ranges from 3400 mg/kg to 4229 mg/kg for rodents (Ferguson. L., J. Lessenger, Agricultural Medicine, Plant growth regulator, pages 156-166 (2006)). Moreover, reports have shown that the application of Ethephon can trigger heterogeneous ripening and rotting during the ripening process, which reduces the shelf life and market value of the produce (Dhall, R., and P. Singh, J. Nutrition and Food Sciences, 3(6): 1000244 (2013)). Thus, natural hormones, especially ethylene, are still proven to be superior to artificial ripening agents.

Therefore, to develop a material for storing natural gaseous plant hormones (i.e., ethylene), and then releasing upon applying to climacteric produce to maintain a hormone level between required ripening concentration and safety allowance, is a major challenge and technology gap facing the produce industry. Recent advances in porous material research may provide a cost-effective solution to this challenge. Zeolite was the first porous ethylene absorbent developed almost two decades ago. Natural zeolite, potassium permanganate impregnated zeolite, and zeolite enhanced films or paper carton-liners are being marketed for ethylene adsorption with horticultural commodities (Sardabi, F., et al., J. Food Processing and Preservation, 38(6): 2176-2182 (2014)). However, although zeolite-based materials are well studied as ethylene absorbent and neutralizer, there have been no reports about the application of zeolite for ethylene storage and release, primarily due to the physiochemical properties of zeolite. The small pore-size (3-8 Å) of the zeolite materials can restrain the exchange and release of gaseous molecules (Chen, W., et al., Current Organic Chemistry, 18: 1323-1334 (2014)). Furthermore, low customizability of zeolite's composition and structure also limits its application in the produce industries because the ethylene treatment conditions can have a significant difference in storage environments, temperature, humidity, and ethylene concentration for different commodities.

Metal-organic framework (MOF) is a recent class of novel materials. MOF have extended polymeric structures formed by coordination bonds between metal atoms and organic ligands. MOF materials are often in the form of highly porous crystalline, and the one-, two-, and three-dimensional polymeric structures are stable during the evacuation process (Li, H., et al., Nature, 402: 276-279 (1999)). Numerous MOF materials have been developed with a large variety of functionalities and applications via adjustment of the ligand property, metal atom, spacer length, as well as synthesis conditions (Li 1999). Currently, the cost of manufacturing MOF materials has been significantly reduced and now is comparable to the zeolite-based materials, but the commercial use of MOF is primarily limited to clean energy-related applications. However, despite the recent advances in MOF research and development, food and agricultural applications are extremely rare because the technology is not readily available and existing MOF materials need to be tailored and customized to meet the challenges from the agricultural industry.

We have developed CuTPA MOFs (e.g., metal-terephthalic acid (TPA)) and applied them, for the first time, as an ethylene storage and release material to stimulate ripening of climacteric fruits.

### SUMMARY OF THE INVENTION

Methods are described for treating plants or fruits, involving contacting the plants or fruits with a solvothermal prepared metal-organic framework which releases at least one gas (e.g., ethylene) to treat the plants or fruits.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the diffraction pattern of CuTPA powders (top) and the indexed identified single crystal diffraction pattern from ICDD database (bottom) as described below.

FIG. 2A and FIG. 2B show the unit cell structure of CuTPA crystals (FIG. 2A) and the hypothetical view of CuTPA with associated channels that provide the high surface area and porosity for ethylene storage (FIG. 2B) as described below.

FIG. 3A and FIG. 3B show micrograph of CuTPA powder from transmission electron microscopy (TEM) (FIG. 3A) and micrograph of CuTPA powder from scanning electron microscopy (SEM) (FIG. 3B) as described below.

FIG. 4A and FIG. 4B show cumulative pore size distribution plots from desorption measured at 77 K (FIG. 4A) and N₂ adsorption-desorption isotherms measured at 77 K as a function of relative pressure (FIG. 4B) as described below.

FIG. 5A and FIG. 5B show ethylene isotherm measured at 25° C. for sample CuTPA (FIG. 5A) and ethylene release from MOF in a 4 liter glass jar (FIG. 5B) as described below.

FIG. 6 shows schematic view of absorption-release cycle of CuTPA as described below.

FIG. 7A and FIG. 7B show changes in textural properties over six days of 1000 ppm ethylene and MOF treatment for banana (FIG. 7A) and avocado (FIG. 7B) as described below.

FIG. 8 shows changes of ethylene concentration over one day of 1000 ppm ethylene and MOF treatment as described below.

FIG. 9 shows changes of O₂ and CO₂ as described below.

### DETAILED DESCRIPTION OF THE INVENTION

Disclosed are methods of storing and/or releasing gases (e.g., ethylene and other gaseous hormones useful in agricultural applications such as O₂, CO₂) in a controlled manner using a crystalline, porous metal-organic framework. The metal ion comprised in the framework is provided by means of a solvothermal method. The framework is highly suitable as storage medium for gases.

The gas to be stored (e.g., ethylene) is brought into contact with a solvothermally prepared metal-organic framework under conditions suitable for absorption of the gas, with absorption of the gas into the metal-organic framework occurring, and, if appropriate, the conditions are subsequently changed so that release of the stored gas occurs. The methods make effective storage of large amounts of gases possible.

The term “MOF” used in the context of the present patent application is equivalent to the term “metal-organic framework”. These terms thus in each case refer to the polymer obtained after the preparation and after removal of impurities, which is made up of metal ions and bridging ligands and may still comprise impurities which cannot be removed by purification, for example anions originating from the synthesis. The MOF comprises no further accompanying substances or auxiliaries, for instance binders, lubricants and extrusion aids which have been used in the processing of the MOFs to produce, for example, tablets or extrudates.

The methods are suitable for storing substances which are preferably gaseous at room temperature. However, it is also possible to store materials having a boiling point above room temperature. In this case, the storage procedure is generally carried out by bringing the material to be stored into the gas phase if necessary and bringing it into contact in the gaseous state with the MOF under suitable conditions. The stored gas can subsequently also be kept at temperatures at which this is once again present as a liquid. To release the stored medium, it may be necessary to heat again to a temperature at which this is present in gaseous form.

The methods are suitable in principle for the storage and/or release of all chemical compounds which are in gaseous form to about room temperature, but also above room temperature. It is possible to store a single compound or a mixture of two or more compounds. Examples include ethylene, saturated and unsaturated hydrocarbons, saturated and unsaturated alcohols, oxygen, nitrogen, noble gases (Ne, Ar, Kr, Xe, Rn), CO, CO₂, synthesis gas (in general CO/H₂) and also natural gases of all possible compositions in addition to gaseous plant and insect hormones. The absorbed gas can also comprise compounds which generate the gases which are subsequently released by the MOF.

Gases which are preferred for the purposes of the present invention comprise ethylene; H₂; H₂-comprising gas mixtures; H₂-producing or -releasing compounds; methane, ethane, propane, butanes, propylene, acetylene, Ne, Ar, Kr, Xe, C0₂, H₂0 and C0₂. Particular preference is given to H₂, CH₄, Kr, Xe, CO₂, CO, and most preferably ethylene.

When the term “storage” of one or more gases is used in the context of the present patent application, this refers to a process in which the gas (e.g., ethylene) comes into contact with the MOF, penetrates into the voids present therein and is adsorbed. In this way, the gas is stored. After this storage, the MOF laden with the gas can, if appropriate, be kept for a period of time before “release” of the gas or the gas mixture occurs.

As mentioned above, the storage is generally carried out at a temperature at which the compound or mixture of compounds to be stored is present in gaseous form. The storage is preferably carried out at a temperature of from 0° to 100° C., in particular from 40 to 30° C.

In the storage and/or release according to the invention, the MOF is generally present in a gastight container. At the end of the storage process, the container accommodating the MOF has an internal pressure which corresponds to the previously applied external pressure. The MOF taking up the gas or gas mixture is therefore also under an external pressure. To release the gas or gas mixture, the pressure acting on the MOF is generally reduced, usually by opening the container accommodating the MOF. This can occur in addition to the pressure reduction, but also as sole measure, particularly in cases in which the pressure acting on the MOF is not higher than atmospheric pressure.

The present invention thus also comprises a gastight container accommodating an MOF material, an opening through which the gas to be stored can enter and a closure mechanism by means of which the interior or the container can be kept under pressure.

The solvothermally prepared MOFs which are used according to the invention for storage are described in more detail below.

MOFs are made up of metal ions which are joined to one another via at least bidentate organic compounds (organic linker or ligand) so that a three-dimensional structure having internal voids (pores) is formed. The pores are defined by the metal atoms and the organic compounds connecting them. An MOF can have exclusively the same metal ions or can have two or more different metal ions.

The term “solvothermal preparation” here refers to a method of preparation in which precursors (organic linker or ligand, and metal salt or metal precursor) for MOF crystal formation are heated in a solvent other than water. In hydrothermal synthesis, precursors for MOF crystals are heated in water. Hydrothermal synthesis is suitable when the ligand precursor is soluble in water. In both conventional solvothermal and hydrothermal synthesis, a solution with MOF precursors is typically maintained at a predetermined equilibrium temperature for an extended period to induce crystallization. Solvothermal and hydrothermal synthesis methods are typically slow, often taking hours and even days.

The term “metal” comprises all elements of the Periodic Table which can be provided in a solvothermal preparation. For the purposes of the present invention, particular preference is given to elements of groups Ia, IIa, IIIa, IVa to VIIIa and Ib and VIb of the Periodic Table of the Elements. Among these elements, preference is given to Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb and Bi. Greater preference is given to Zn, Cu, Ni, Pd, Pt, Ru, Rh, Fe, Mn, Ag and Co. Cu, Fe, Co, Zn, Mn and Ag are more preferred. Very particular preference is given to Cu.

The process is generally carried out at a temperature in the range from 0° C. to the boiling point of the respective reaction medium or the at least one solvent used, preferably in the range from 20° C. to the boiling point, preferably above atmospheric pressure. It is likewise possible to carry out the process under superatmospheric pressure, with pressure and temperature preferably being chosen so that the reaction medium is preferably at least partly liquid. In general, the process is carried out at a pressure in the range from 0.5 to 50 bar, preferably in the range from 1 to 6 bar and particularly preferably at atmospheric pressure.

In a preferred embodiment, the reaction medium comprises at least one suitable solvent in addition to the at least one at least bidentate organic compound. Here, the chemical nature and the amount of this at least one solvent can be matched to the at least one at least bidentate organic compound and/or to the at least one metal ion.

Accordingly, methods are described wherein the reaction medium further comprises at least one solvent in addition to the at least one at least bidentate organic compound.

Conceivable solvents are in principle all solvents or all solvent mixtures in which the starting materials used in the process can be at least partly dissolved or suspended under the reaction conditions, e.g. pressure and temperature, selected. Examples of preferred solvents are, inter alia,
water;
alcohols having 1, 2, 3 or 4 carbon atoms, e.g. methanol, ethanol, n-propanol, isopropanol, n-butanol, isobutanol, tert-butanol;
alkanes such as hexane;
carboxylic acids having 1, 2, 3 or 4 carbon atoms, e.g. formic acid, acetic acid, propionic acid or butanoic acid;
nitriles such as acetonitrile or cyanobenzene; ketones such as acetone;
at least singly halogen-substituted lower alkanes such as methylene chloride or 1,2-dichloroethane;
acid amides such as amides of lower carboxylic acids, e.g. carboxylic acids having 1, 2, 3 or 4 carbon atoms, for example amides of formic acid, acetic acid, propionic acid or butanoic acid, e.g. formamide, dimethylformamide (DMF), diethylformamide (DEF), t-butylformamide, acetamide, dimethylacetamide, diethylacetamide or t-butylacetamide;
cyclic ethers such as tetrahydrofuran or dioxane; N-formylamides or N-acetylamides or symmetrical or unsymmetrical urea derivatives of primary, secondary or cyclic amines such as ethylamine, diethylamine, piperidine or morpholine;
amines such as ethanolamine, triethylamine or ethylenediamine;
dimethyl sulfoxide;
pyridine;
trialkyl phosphites and phosphates;
or mixtures of two or more of the above mentioned compounds.

The term “solvent” as used above includes both pure solvents and solvents which comprise small amounts of at least one further compound such as, preferably, water.

Preferred solvents for use are methanol, hexane, DMF and water and mixtures of two or more of these compounds.

The pH of the reaction medium is set so that it is advantageous for the synthesis or the stability or preferably for the synthesis and the stability of the framework. For example, the pH can be adjusted by means of the at least one electrolyte salt.

If the reaction is carried out as a batch reaction, the reaction time is generally in the range up to 72 hours, preferably in the range up to 48 hours, more preferably in the range up to 24 hours.

The term “at least bidentate organic compound” refers to an organic compound comprising at least one functional group which is able to form at least two, preferably two, coordinate bonds to a given metal ion and/or to form a coordinate bond to each of two or more, preferably two, metal atoms.

Examples of functional groups via which the coordinate bonds mentioned can be formed are, in particular, those disclosed in U.S. Pat. No. 7,553,352. Very particular preference is given to using, inter alia, terephthalic acid.

Climacteric fruits such as bananas and avocados can be easily shipped, and stored for weeks and months at the unripe stage. However, they usually only last for a few days once they are ripened. The produce industry is interested in regulating the ripening process of climacteric produce during production, storage, transportation, and retail. Currently, producers usually harvest and ship these fruits to the distribution centers at the unripe stage. The distributors then treat the fruits with ethylene gas and ship the treated fruits to the retailers. Because of the difficulty in controlling the ripening stage and timing, the fruits sold in the markets are often too unripe to eat, or too ripe to store. Our MOF-Ethylene allows supermarkets and consumers to ripen the fruits where they want, and when they want (“ripen by design/desire”). Therefore this technology not only will provide the perfectly ripe fruits to the consumers, but also significantly reduce the post-harvest losses of fruits in supply chain. Furthermore, our MOF-Ethylene may allow shippers to treat the fruits during ocean transportation of imports and exports and allow the fruits to reach the desired ripening stage upon arrival at the destination.

Our porous metal-organic framework (MOF) can be used to store and release gaseous materials (e.g., such as a plant hormone like ethylene for agricultural applications). The gaseous plant hormone, ethylene, acts at trace levels to stimulate or regulate the ripening of climacteric produce, the opening of flowers and the abscission of leaves. Ethylene gas has been widely used commercially to stimulate ripening of bananas, avocados, tomatoes, mangos, etc. However, ethylene is highly flammable and combustible at concentrations above 27,000 ppm, and therefore it requires special care during shipping, storage, and application. The most common sources of ethylene gas are catalytically generated during the incomplete combustion of organic fuels of propane and natural gas, which also requires on-site maintenance of flammable gases. Therefore, direct application or on-site generation of ethylene gas is difficult and unsafe to handle at retail stores and homes of consumers.

Our MOF can be used for storing natural gaseous plant hormones (e.g., ethylene), and then releasing the volatile at levels to maintain a desired concentration. In the case of ethylene, this volatile will be released at hormones levels between a concentration required for ripening and a concentration within safety limits, the later limit being a major challenge and technology gap facing the produce industry.

Using the MOF material and methods described herein, a 50 mg MOF can absorb and release enough ethylene to reach a concentration of 10 ppm in a 4 L container. The MOF is a solid matrix so that storage, transportation and application practices can be made safely and efficiently.

After heat activation, the MOF granules can be transferred to a preparation chamber and charged (by absorption) with ethylene. This is accomplished by subjecting the porous granular product to a vacuum for five minutes to empty the pores of the granular material, and thereafter purging the chamber with pure ethylene gas until ambient pressures were achieved. The vacuum and purge process allows for a high exchange and storage efficiency of ethylene inside the pores of the MOF.

The ethylene charged MOF materials can be transferred to a produce container, containing for instance, unripe bananas, avocados, tomatoes, etc., and retained therein for 24 to 48 hours to stimulate the ripening process.

Storage containers for the MOF particle and produce include, for instance, generally air-tight plastic bags, permeable plastic bags, paper bags, and shipping boxes.

There are several advantages to using MOF charged with, for example, ethylene: the first “solid” ethylene source for agricultural application; solid material is safer, and less flammable than pure ethylene; solid material can be easy to transport or apply to individual packages; low cost- and time-efficient method; reagents are cheap; efficient absorption (inward) or release (outward); the MOF material can be regenerated and thus can be reused by simple heating (as absorbent), or recharged (as source); accelerates the ripening of climacteric fruits; can be used to explore other applications of MOF on different volatile compounds such as for the timed release of gaseous insect hormones or pheromones.

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

Solvothermal synthesis of MOF: The MOF matrices were synthesized via solvothermal method (Carson, C., et al., Eur. J. Inorg. Chem. 2338-2343 (2009)). 74 mg of Copper (II) acetate and 92 mg of terephthalic acid (TPA) were dissolved in a solvent system (i) of 10 mL dimethylformamide (DMF) and 10 mL methanol or a solvent system (ii) of 15 mL hexane and 5 mL of water inside a Teflon® lined autoclave reactor. The MOF product can be synthesized by heating the reactor at either 120° C. for 48 hours or 180° C. for 24 hours. The crystalline bluish solids were centrifuged for 5 minutes at 5,000 g and washed three times with ethanol. The product was dried and activated in a vacuum oven at 100° C. for 12 hours.

Characterization of MOF using scanning electron microscopy: Electron microscopy images were captured utilizing a S-3700 VPSEM (Hitachi High Technologies America, Inc., Pleasanton, Calif.) with a Deben Coolstage Peltier stage (Deben UK Ltd., Suffolk, UK) set at −25° C. All images were captured at 1000× magnification at 10 kV accelerating voltage, 10 mm working distance, and 40 Pa vacuum level.

X-ray Diffraction (XRD): XRD was used to characterize the chemical composition of the nanofiller and the nanofiller orientation inside zein resin films. Nanofiller powder and resin films were attached to specimen stubs by flat double-sided tape. Powder diffraction was measured using a Bruker D8 Advance powder diffractometer operated in Bragg-Brentano mode (θ-θ geometry), equipped with a CuKα sealed tube (wavelength of 1.541 78 Å), Ni β-filter, and positionsensitive LynxEye detector. After measurement, phase identification was performed using the International Center for Diffraction Data (ICDD) powder diffraction database.

Scanning electron micrographs were captured utilizing a S-3700 VPSEM (Hitachi High Technologies America, Inc., Pleasanton, Calif., USA) with a Deben Coolstage Peltier stage (Deben UK Ltd., Suffolk, UK) set at −25° C. All images were captured at 1000× magnification at 10 kV accelerating voltage, 10 mm working distance, and 40 Pa vacuum level.

For transmission electron microscopy (TEM), solutions were applied directly onto 400 mesh carbon-coated copper grids and allowed to absorb for 30 minutes, excess solution was wicked off and grids were air dried. Grids were then incubated at ambient temperature for 12 hours order to crystallize. Grids were imaged at 80 kV with a Hitachi HT-7700 transmission electron microscope (Hitachi, Tokyo, Japan).

N₂ isotherms were measured on a Micromeritics TriStar II Plus unit to full saturation, i.e., a relative pressure of approximately ˜1.0 at 77 K to enable BET surface area and TOPV analyses to be performed. In addition, a low pressure (P<1 atm) ethylene isotherm was measured on a Micromeritics ASAP unit at 25° C. The samples were activated on a Smart VacPrep degas unit by degassing in stages up to 150° C. with a series of ramp/soak steps under dynamic vacuum. Sample preparation was performed by drawing vacuum on the sample at ambient temperature, raising the temperature at 1° C./min to 80° C., holding at 80° C. until a vacuum level of <10⁻³ torr was achieved, and then holding the sample at 80° C. for an additional hour. The temperature was then ramped at 10° C./min to a series of preset temperatures following the same protocol, i.e., maintaining the set temperature until a vacuum level of <10⁻³ torr was attained, and then holding the sample at the set temperature for an additional hour. The preset temperatures used were 100, 120, and 150° C. The sample was held at the final temperature until a vacuum level of <10⁻⁴ torr was achieved.

Measurements of N₂ BET on standard materials suggest accuracy to within approximately 5% at surface area values of 10 m²/g and approximately 10% at levels of ˜0.5 m²/g when at least 50 m² of material are available for testing within the sample cell. Repeatability for any given sample is dependent on the ability to regenerate the sample to the same degree of activation without modifying the surface or the pore structure. The cumulative volume was calculated based on a BJH analysis which relates pore size to relative pressure. In this analysis a Halsey correction was used to account for monolayer thickness coverage.

Charging MOF with ethylene: after activation, the MOF was transferred to a preparation chamber and charged (absorption) with pure ethylene by vacuum in the chamber for 5 minutes and purge pure ethylene gas till ambient pressure. The vacuum and purge process allowed high exchange and storage efficiency of ethylene inside the MOF pores.

Application of MOF-ethylene for fruit ripening: To apply the ethylene-charged MOF material, the charged MOF was transferred to the produce container and 24 to 48 hours of stimulated ripening process of avocados, grocery bananas, and non-gassed bananas were conducted. Avacados and grocery bananas (pretreated at warehouse or retail facility) were acquired directly from local supermarket, and ‘non-gassed’ bananas were directly purchased from local produce distribution center (Coastal Sunbelt, Jessup, Md.). Each produce was randomly grouped for different treatments with 1000 ppm ethylene standard, ethylene-charged MOF, and air with no ethylene.

Ethylene levels in the container were measured using a gas chromatograph (HP 5890A, Hewlett Packard Suite 200 W Golden, Colo.) equipped with a GS-Q column (3 m×0.53 mm; J & W Scientific, Folsom, Calif.) and a flame ionization detector. The flow velocity of carrier gas (He) was 0.5 mL/s. Detector, oven (column), and injector were operated at 250, 70, and 200° C. (Kim, J., et al., Postharvest Biology and Technology, 46: 144-149 (2007)). Ethylene levels were expressed in units of microliter per liter (μL/L).

Quality evaluation of fruits treated with MOF-ethylene: The O₂ and CO₂ concentrations within the container were measured using a gas analyzer system (Gaspace Advance GS3 Micro, Illinois Instrument, Johnsbury, Ill.). The analyzer took 2.5 mL of the headspace over 15 seconds to give an accurate and stable reading. Each measurement was repeated at least three times. The texture of the fruited treated with MOF-ethylene was evaluated based on tensile property, including tensile strength and Young's modulus, using a texture analyzer (TA.XT plus, Stable Micro System, Surrey, U.K.). A 10 mm flat probe was used to punch the peeled produce. The texture analyzer was set to a compression rate of 5 mm/min. Five replicates were measured for each measurement.

The color change of the produce was measured using a Minolta colorimeter (Minolta Co. Ltd, Japan). The L values reported were means of 12 readings; three readings from each side of each of the bananas, and two readings per avocado. For bananas, ‘a’ was an indicator of green, and higher ‘a’ value meant less green; ‘b’ was an indicator of yellow, and higher ‘b’ value meant more yellow. For avocados, the degree of browning was expressed by the percent decrease in the L value calculated by subtracting the L value of treated and control samples measured at evaluation times from the time zero L value obtained from untreated samples measured immediately after cutting, divided by the time zero value and multiplied by 100.

Tensile Property. The tensile property, including tensile strength and firmness were measured using a texture analyzer (TA.XT plus, Stable Micro System, Surrey, U.K.). Banana and avocado samples were first peeled before the compression measurement. The textural property was measured with fruit pulp only, using a cylinder probe with the diameter of 75 mm. The compression rate was 0.5 mm/second, and the penetration distance was 10.0 mm. At least five replicates were measured for each treatment.

Results and Discussion. MOF synthesis and characterization. X-Ray Diffraction: The solvothermal synthesis of CuTPA resulted in a blue powder of mixed MOF crystals. The synthesis was conducted according to Carson et al. (2009) with minor revision (Equation 1). Sealed autoclave reactors with teflon liners were used in the solvothermal synthesis of CuTPA to create a high-pressure environment of methanol vapors, which facilitated the high-quality crystal growth by forcing the dissolution of dimethylamine base and the deprotonation of the terephthalic acid (Carson, 2009).

$${Cu ( {CH}_{3} COO )}_{2} + {C}_{6} {{H}_{4} ( COOH )}_{2} Cu [ {C}_{6} {{H}_{4} ( COO )}_{2} ] ) + 2 {CH}_{3} COOH \qquad Equation 1$$

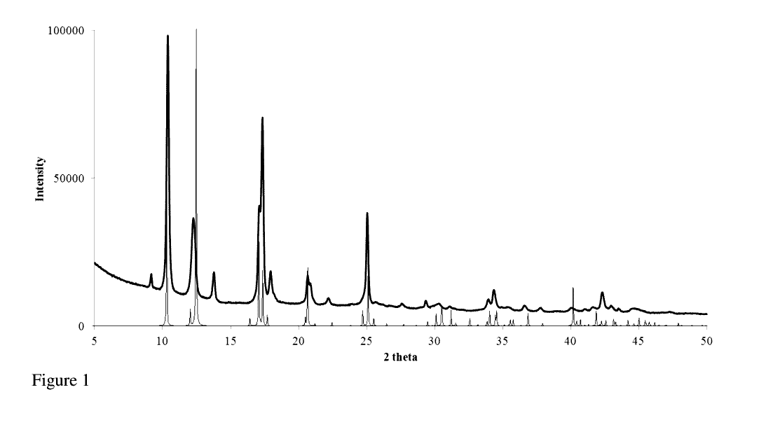

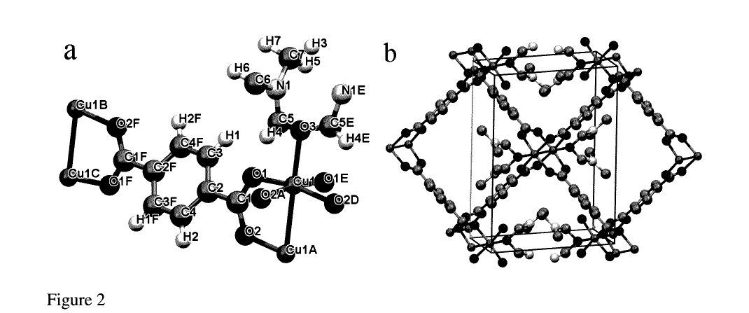

The XRD analysis was carried out to verify the crystal composition structure. The powder diffraction patterns (FIG. 1) can be identified as the previously reported single crystal CuTPA from the ICDD database (Carson 2009). However, the peak intensity of CuTPA powder at 12.2o, depicted as the (201) plane, was slightly lower than that of its single crystal, which could be contributed to the anisotropic property of the powder diffraction, whereas the single crystal diffraction was isotropic. FIG. 2a shows the crystal structure of the powder CuTPA. In the complex, TPA ligands formed bidentate coordination bonds with the Cu^{II} dimer, and each Cu^{II} atom was also linked to a DMF molecule, similar to the previously reported zinc terephthalate (MOF-2) (Clausen, H. F., et al., J. Solid State Chem., 178: 3342-3351 (2005)). FIG. 2b shows the hypothetical view of the channels and pores inside the CuTPA crystals, which were formed by layers of the laminated structures that are covalently bonded in the (001) plane.

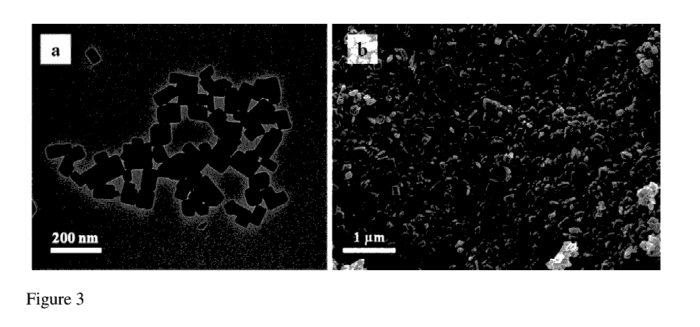

Electron microscopy: FIG. 3a shows the TEM micrograph of the as obtained CuTPA powder. The particles appeared cubic in shape with a diameter of about 87±32 nm measured via dynamic light scattering. The SEM micrograph (FIG. 3b) showed similar morphology and particle size. The micropores formed as cavities and crevasses when CuTPA powders were closely packed could be used to improve the ethylene storage capacity.

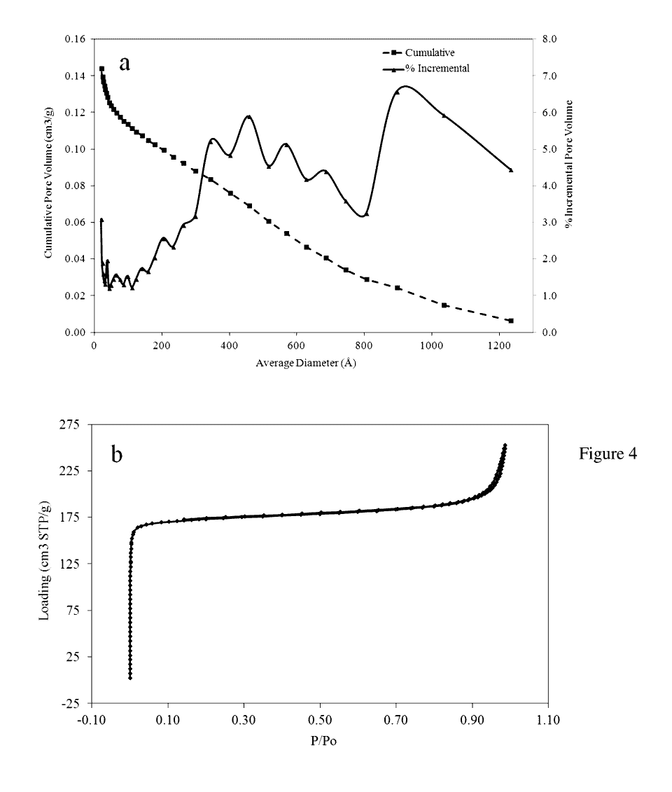

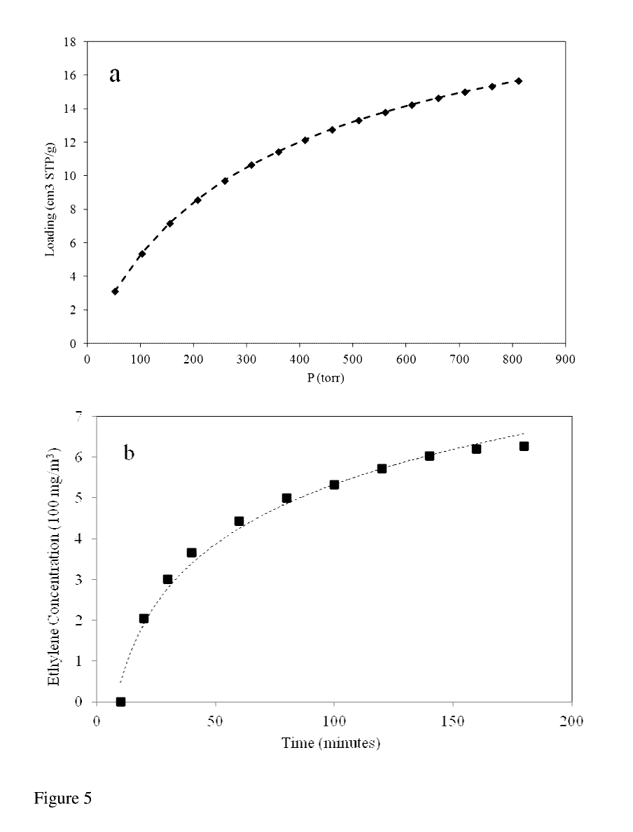

Porosity and ethylene storage capacity: The N₂ isotherms reveal that the specific surface area was relatively high for CuTPA with a BET surface area of 708 m²/g. The total pore volume was 0.39 cm³/g and the micropore volume was 0.246 m³/g. The majority of the pores were <20 Å and represent approximately 63% of the total pore volume (FIG. 4a). The effect of hysteresis loop was not significant between the adsorption and desorption branches of the isotherm for CuTPA, suggesting that the crevasses among closely packed particles were micropores instead of mesopores (FIG. 4b). The ethylene isotherm at 25° C. is presented in FIG. 5a. FIG. 5b shows the release kinetics of ethylene from MOF to a 4 L container. The release profile was a hyperbolic curve, indicating the release rate of ethylene was at peak when the charged MOF was immediately moved to a new container filled with air. The decrease in release rate over time could be attributed to the reduced partial pressure difference between the container and the interior of the MOF.

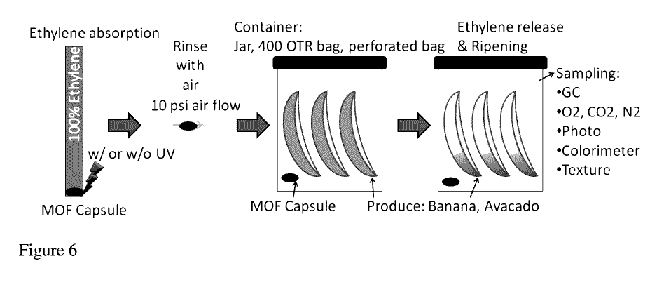

Controlled ripening of climacteric produce: The as obtained CuTPA MOF was investigated as a solid ethylene storage and release matrix. FIG. 6 illustrates the controlled ripening of climacteric produce via CuTPA-mediated ethylene absorption and release.

Color change during controlled ripening: The avocados did not show significant color changes whereas banana color changed significantly. Banana showed obvious color change after ethylene treatment with both the standard and the MOF. The ripening of produce was stimulated by the treatment. The total ripening time required was reduced by a half. FIG. 5 shows the comparison of color change after 48 hours of treatment. Samples treated with either 1000 ppm ethylene or MOF were fully ripened, whereas control samples still needed further treatment. Table 1 shows the colorimetric analyses of banana and avocado surfaces. Banana samples treated with 1000 ppm ethylene or MOF showed significant decrease in green (higher a value) and increase in yellow (higher b value), while the control remained unchanged compared to the measurement before ripening treatment (t=0). From an increase in yellow (b value) and a decrease in green (a value) it can be seen that bananas treated with 1000 ppm ethylene or MOF ripened significantly after only 2 days.

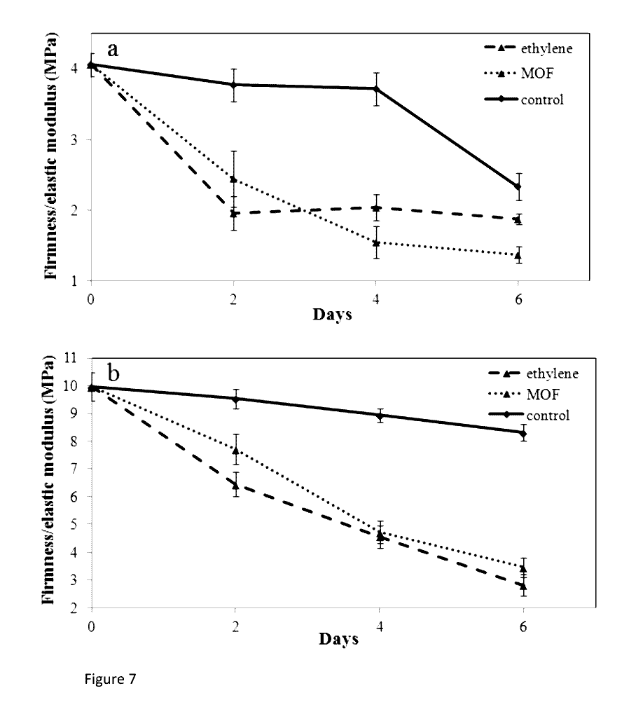

Texture: The tensile property of bananas (shown in FIG. 7, including tensile strength and elasticity) had significant differences between produce with and without ethylene treatment. The Young's modulus (initial slope) indicated bananas became less elastic and more viscous after ethylene and MOF treatments. The decrease in tensile strength (maximum stress at break) also indicated an increase in tissue softness after the ethylene and MOF mediated ripening process. The MOF treatment decreased the firmness of the banana by 40% in 2 days while the bananas not exposed to ethylene only decreased in softness by 15%. The skin color of avocado, in contrast, darkened slightly after ethylene standard and MOF treatment (Table 1), but the flesh softened significantly after 48 hours of ethylene treatment (FIG. 7). The avocado not exposed to any ethylene remained firm after the 2 days treatment.

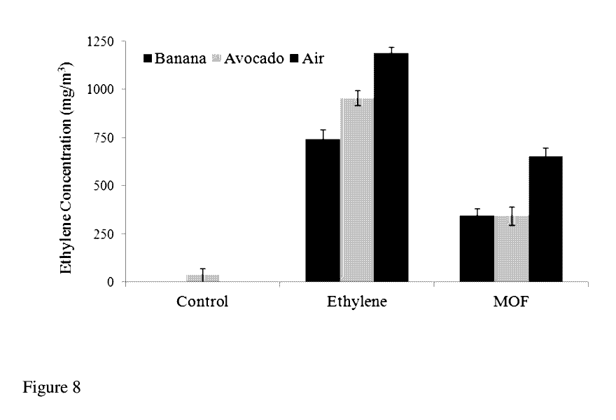

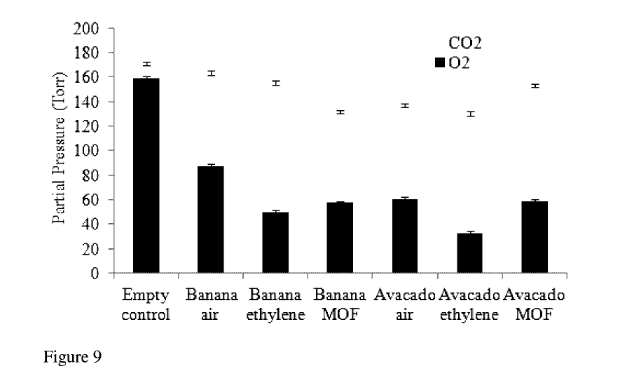

Headspace gas composition of the containers: The gas composition of the seal jar, including ethylene, oxygen and carbon dioxide, was monitored during the ripening of banana and avocado (shown in FIG. 8 and FIG. 9). FIG. 8 shows the change of ethylene concentration in a 4 L jar after one day of ripening. MOF charged with ethylene gas can release up to 700 ppm of ethylene in the sealed environment from only a 1 mg sample of material (FIG. 8). The stored produce absorbed the gaseous ethylene which stimulated ripening process which can be proven by what is seen from the change of O₂ and CO₂ composition due to the respiratory activities. When the ripening process was stimulated, the produce consumed more ethylene and O₂ to generate more CO₂ (FIG. 9).

Similar results were also found in green banana (also known as ‘no gas’ banana), which unlike bananas purchased in local grocery stores were not treated with ethylene at the local distribution facility, are normally stored at local distribution facility, and treated with ethylene immediately prior to shipping to local grocery stores. From the color measurements, texture measurements, and headspace gas measurements, MOF was proven as effective as ethylene standards for increasing the rate of ripening, and it does not require any hazardous treatments at the distribution facility. In addition, the MOF was also tested and proven effective in different types of packaging materials, including plastic bags, permeable plastic bags, paper bags and shipment boxes, which were close to real-world scenarios during the ripening of climacteric produce. These factors suggest the MOF material could be a safer and simpler technology used to ripen bananas and other fruit than the current method.

Conclusion: A porous CuTPA metal-organic framework (MOF) was synthesized and used to store and release gaseous materials such as ethylene, a ripening hormone, for agricultural applications. The MOF matrices were synthesized via a solvothermal method. A 50 mg MOF can absorb and release enough ethylene to reach a concentration of 10 ppm in a 4 L container to allow rapid ripening of climacteric produce, including banana and avocado. Because the MOF is a solid matrix, the storage, transportation and application of ethylene can be made safer and more efficient.

All of the references cited herein, including U.S. Patents, are incorporated by reference in their entirety. Also incorporated by reference in their entirety are the following references: Clausen, H., et al., J. Solid State Chemistry, 178(11): 3342-3351 (2005); David J. Tranchemontagne, D. J., et al., Tetrahedron, 64; 8553-8557 (2008); U.S. Pat. No. 7,553,352; U.S. Pat. No. 7,880,026; U.S. Patent Application Publication 20140348986; U.S. Patent Application Publication 20060121167.

Thus, in view of the above, there is described (in part) the following:

A method for treating plants or fruits, comprising (or consisting essentially of or consisting of) contacting said plants or fruits with a solvothermal prepared metal-organic framework which releases at least one gas to treat said plants or fruits.

The above method, wherein the solvothermal prepared metal-organic framework comprises at least one metal of groups Ia, IIa, IIIa, IVa to VIIIa and Ib and VIb, of the Periodic Table of the Elements. The above method, wherein said at least one metal is Cu.

The above method, wherein the solvothermal prepared metal-organic framework comprises at least one bidentate organic compound. The above method, wherein said at least one bidentate organic compound is terephthalic acid.

The above method, wherein said gas is ethylene.

The above method, wherein said fruits are bananas.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Color change of bananas and avocados after ethylene mediated ripening treatment.

| | L | a | b | c | h |
|---|---|---|---|---|---|
| Banana (t = 0) | 70.78 ± 0.17 | −8.13 ± 0.33 | 38.12 ± 0.78 | 38.98 ± 0.85 | 102.04 ± 0.67 |
| Banana (control) | 67.63 ± 1.80 | −7.63 ± 0.74 | 38.77 ± 0.82 | 39.51 ± 1.10 | 101.13 ± 0.48 |
| Banana | 66.74 ± 0.77 | −1.66 ± 0.57 | 45.77 ± 4.60 | 45.80 ± 4.64 | 92.08 ± 0.83 |
| (1000 ppm) | | | | | |
| Banana (MOF) | 70.26 ± 0.45 | −2.34 ± 0.08 | 45.88 ± 3.68 | 45.94 ± 3.68 | 92.92 ± 0.89 |
| Avocado (t = 0) | 32.30 ± 0.35 | −8.70 ± 1.43 | 18.12 ± 0.68 | 20.10 ± 1.58 | 115.65 ± 0.25 |
| Avocado | 27.96 ± 0.88 | −1.05 ± 3.68 | 11.36 ± 3.04 | 11.41 ± 4.77 | 95.28 ± 0.39 |
| (control) | | | | | |
| Avocado | 30.17 ± 0.23 | −1.31 ± 3.01 | 13.54 ± 1.66 | 13.60 ± 3.44 | 95.53 ± 0.29 |
| (1000 ppm) | | | | | |
| Avocado (MOF) | 26.91 ± 0.63 | 0.52 ± 0.11 | 8.81 ± 0.21 | 8.83 ± 0.24 | 86.62 ± 0.62 |

We claim:

1. A method for treating plants or fruits, comprising contacting said plants or fruits with a solvothermal prepared metal-organic framework which releases at least one gas to treat said plants or fruits.

2. The method according to claim 1, wherein the solvothermal prepared metal-organic framework comprises at least one metal of groups Ia, IIa, IIIa, IVa to VIIIa and Ib and VIb, of the Periodic Table of the Elements.

3. The method according to claim 2, wherein said at least one metal is Cu.

4. The method according to claim 1, wherein the solvothermal prepared metal-organic framework comprises at least one bidentate organic compound.

5. The method according to claim 4, wherein said at least one bidentate organic compound is terephthalic acid.

6. The method according to claim 1, wherein said gas is ethylene.

7. The method according to claim 1, wherein said fruits are bananas.
